(19) United States
(12) Patent Application Publication
(10) Pub. No.: US 2023/0150636 A1
(43) Pub. Date: May 18, 2023

(54) CLOSED LOOP HEAT EXCHANGER INTEGRATED IN A LOWER DRIVE UNIT

(71) Applicant: Forza X1, Inc, Fort Pierce, FL (US)

(72) Inventors: Daniel Norton, Apex, NC (US); Jean-Marc Zanni, Fort Pierce, FL (US)

(73) Assignee: Forza X1, Inc, Fort Pierce, FL (US)

(21) Appl. No.: 18/150,943

(22) Filed: Jan. 6, 2023

Related U.S. Application Data
(63) Continuation-in-part of application No. 17/698,212, filed on Mar. 18, 2022.
(60) Provisional application No. 63/297,013, filed on Jan. 6, 2022.
(60) Provisional application No. 63/207,748, filed on Mar. 18, 2021.
(60) Provisional application No. 63/293,420, filed on Dec. 23, 2021.

(51) Int. Cl. B63H 20/28; B63H 20/08; H02K 5/132; H02K 5/20; H02K 7/116; H02K 9/193; H02K 11/33

(52) U.S. Cl. CPC B63H 20/28; B63H 20/08; H02K 5/132; H02K 5/203; H02K 7/116; H02K 9/193; H02K 11/33

(57) ABSTRACT

A closed loop heat exchanger system for use with an outboard motor, wherein the heat exchanger assembly is disposed in the housing portion of the lower drive unit of the outboard motor where the propulsion assembly resides. The heat exchanger assembly being in thermal communication with the external surface of the housing of the lower drive unit, thus eliminating the need for an external raw water intake on the lower housing portion and reducing or eliminating components associated with a raw water pump system.

### REFERENCE TO RELATED APPLICATIONS

This application claims the benefit of U.S. Provisional Patent Application No. 63/297,013 filed on Jan. 6, 2022 which is herein incorporated by reference in entirety and is a continuation-in-part of U.S. patent application Ser. No. 17/698,212 filed Mar. 18, 2022, which claims the benefit of U.S. Provisional Patent Application No. 63/207,748 filed on Mar. 18, 2021 and 63/293,420 filed on Dec. 23, 2021 which are also herein incorporated by reference in their entirety.

### FIELD AND BACKGROUND OF THE INVENTION

The present invention relates to a novel closed loop heat exchanger integrated in a lower drive unit for a boat motor system that could include outboard motor systems, stern drive systems and the like for marine propulsion.

There exists a need for a closed loop heat exchanger that can be integrated in a lower drive unit that can provide cooling to the motor and electronics. This closed loop heat exchanger eliminates the need for a raw water pump to circulate cooling water (usually raw water from the lake or sea) around a heat exchanger which is used to cool the motor. The elimination of the raw water pump also eliminates the need for extra hoses and additional controls needed to cool the motor, electronics and other components.

The present embodiments seek to solve these and other problems that will be apparent to those skilled in the art.

### SUMMARY OF THE INVENTION

In one embodiment a closed loop heat exchanger system for use with an outboard motor comprises: a lower drive unit configured to support a propulsion system, wherein a majority of the lower drive unit is disposed in the water when in operation; a heat exchanger assembly disposed internally within the lower drive unit, and configured to be in thermal communication with an external surface of the lower drive unit; and a fluidic pump in fluid communication with the heat exchanger assembly; an inlet channel directing a cooling fluid from the fluidic pump into the lower drive unit and into the heat exchanger assembly; and an outlet channel directing the cooling fluid having passed through the heat exchanger assembly into, over or about heat generating motor components disposed outside the lower drive unit.

The heat generating motor components of the above embodiment can include at least one of: an electric motor, an inverter and gear reducer.

The above closed loop heat exchanger system embodiment can further include a hub assembly disposed on an upper portion of the lower drive unit and wherein the hub assembly forms a part of the inlet channel and the outlet channel. In a variation, the hub assembly includes a cavity portion that is configured to receive a portion of a lower drive shaft therein.

The heat exchanger assembly in the above embodiment can be comprised of at least one channel traversing about itself along at least one plane. In a variation, the traversing channel is formed into a sidewall of a housing of the lower drive unit.

In another variation to the above embodiment the heat exchanger assembly can be comprised of a first set of traversing channels disposed about a rear portion of the lower drive unit and a second set of traversing channels disposed about the front portion of the lower drive unit. In this variation, the traversing channels can also at least partially be formed into one or more sidewalls of a housing of the lower drive unit, wherein the one or more sidewalls form a portion of an exterior surface of the housing.

The hub assembly in the above embodiment can enable the lower drive unit to be rotated 360 degrees when connected to a slewing assembly.

In yet another embodiment, a closed loop heat exchanger system for use with a stern drive comprises a lower drive unit configured to support a propulsion system, wherein a majority of the lower drive unit is disposed in the water when in operation; a heat exchanger assembly disposed internally within the lower drive unit, and configured to be in thermal communication with an external surface of the lower drive unit; and a fluidic pump in fluid communication with the heat exchanger assembly; an inlet channel directing a cooling fluid from the fluidic pump into the lower drive unit and into the heat exchanger assembly; and an outlet channel directing the cooling fluid having passed through the heat exchanger assembly into, over or about heat generating motor components disposed outside the lower drive unit.

The heat generating motor components can include at least one of: an electric motor, an inverter and gear reducer.

The above closed loop heat exchanger system embodiment for use with a stern drive can further include a hub assembly disposed on an upper portion of the lower drive unit and wherein the hub assembly forms a part of the inlet channel and the outlet channel. In a variation, the hub assembly includes a cavity portion that is configured to receive a portion of a lower drive shaft therein.

The heat exchanger assembly in the stern drive embodiment can be comprised of at least one channel traversing about itself along at least one plane. In a variation, the traversing channel is formed into a sidewall of a housing of the lower drive unit.

In another variation to the stern drive embodiment the heat exchanger assembly can be comprised of a first set of traversing channels disposed about a rear portion of the lower drive unit and a second set of traversing channels disposed about the front portion of the lower drive unit. In this variation, the traversing channels can also at least partially be formed into one or more sidewalls of a housing of the lower drive unit, wherein the one or more sidewalls form a portion of an exterior surface of the housing.

The hub assembly in the stern drive embodiment can enable the lower drive unit to be rotated 360 degrees when connected to a slewing assembly.

In yet another embodiment cooling channels, pockets or crevices can be created in portions of the lower drive unit that have available space. In some instances, the skeg fin or anti-cavitation plate can be sized sufficiently to have cooling channels that form part of the integrated heat exchange assembly in the lower drive unit.

These and other embodiments will become apparent to those skilled in the art upon further review of the description below.

### BRIEF DESCRIPTION OF DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a standard or traditional outboard lower unit diagram consisting of a cooling pump, pumping a cooling liquid through the motor, a raw water pump circulating fluid through a heat exchanger, in which the cooling fluid also passes through, thus cooling the liquid which in turn cools the motor.

FIG. 2 illustrates a diagram of an improved closed loop heat exchanger system where the heat exchange portion is disposed in a lower drive unit of a boat motor assembly.

FIGS. 3A-C illustrates various views of a lower drive unit of a boat motor assembly that contains the propulsion system.

FIG. 4A illustrate a top view of a lower drive unit of a boat motor assembly that contains the propulsion system.

FIG. 4B is a cross-sectional view of 4A illustrating the internal components of the lower drive unit including the improved heat exchanger system.

FIG. 4C is cross-sectional view of 4A illustrating the flow path of the cooling circuit.

FIGS. 5A-C illustrate the Hub assembly that includes integrated inlet and outlet cooling channels.

FIGS. 6A-B illustrate an alternative embodiment of positioning the heat exchanger cooling channels in the lower drive unit.

### DETAILED DESCRIPTION OF THE INVENTION

As noted, this application relates to a closed loop heat exchanger in a lower drive unit. One of the advantages of the closed loop heat exchanger system described herein is that it uses the space provided inside the housing of the lower drive unit, and a series of channels routed therein to maximize the heat transfer of the warmer internal (cooling) fluid and the cooler external seawater/freshwater that the housing of the lower drive unit is sitting in. These advantages become even more pronounced when pairing this system with an electric motor, as that enables more space in the lower drive unit to become available. Often combustion motors will have an exhaust system that passes through the housing of the lower drive unit; thus, without the need to exhaust gases generated from the combustion process an electric motor doesn't require the extra channeling and therefore frees up additional space. Having said that the embodiments described herein can be utilized with both combustion and electric motors, noting only that electric motors provide more flexibility and options.

The closed loop heat exchanger embodiments described herein, are also configured to work well with outboard motor systems having 360 degree rotational capabilities of the lower drive unit, examples of which are taught and described in U.S. application Ser. No. 17/698,212 and which are being provided in an Appendix below.

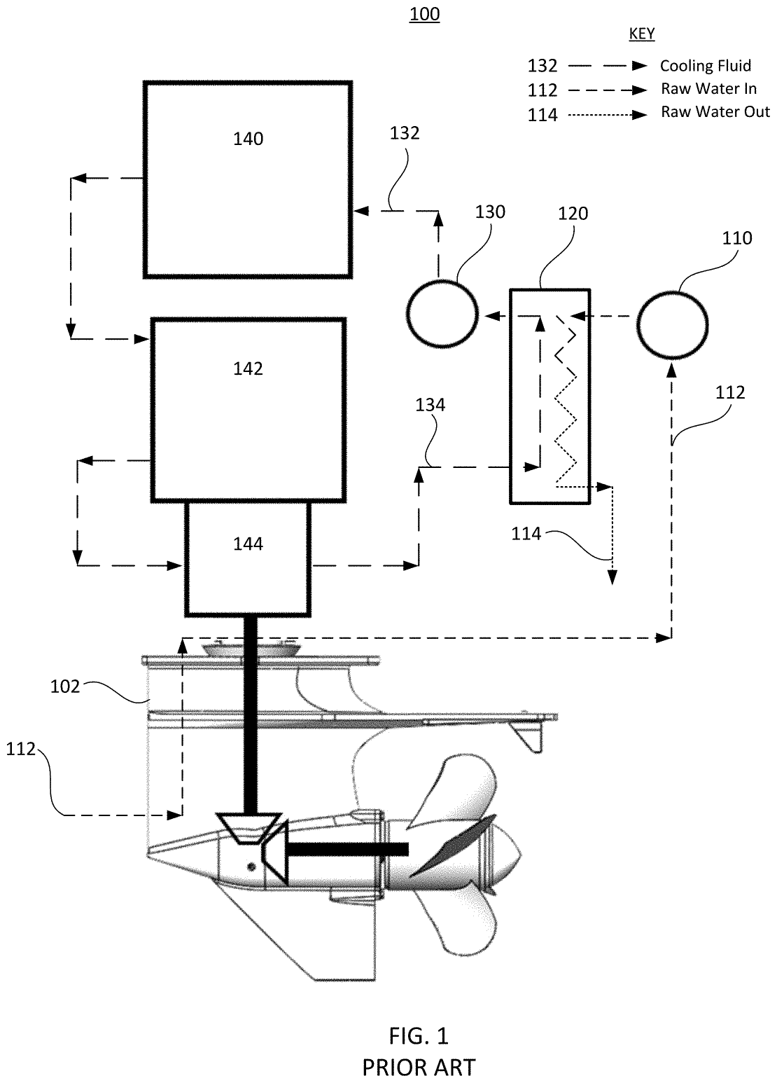

Referring now to FIG. 1, which illustrates a standard or traditional outboard lower unit diagram for using external water to provide cooling. In this diagram 100, raw water 112 is sucked up through the lower drive unit 102 using a raw water pump 110, which passes through a heat exchanger unit 120, where afterwards the raw water 114 exits the system. The heat exchanger unit 120 is connected in line with a closed cooling circuit that includes a cooling pump 130 that pumps the cooled cooling fluid 132 into or by various engine components 140, 142 and 144, extracting heat from each and enters 134 the heat exchanger unit 120 at an elevated temperature state, where the raw water extracts the heat from the cooling fluid and the cycle continues.

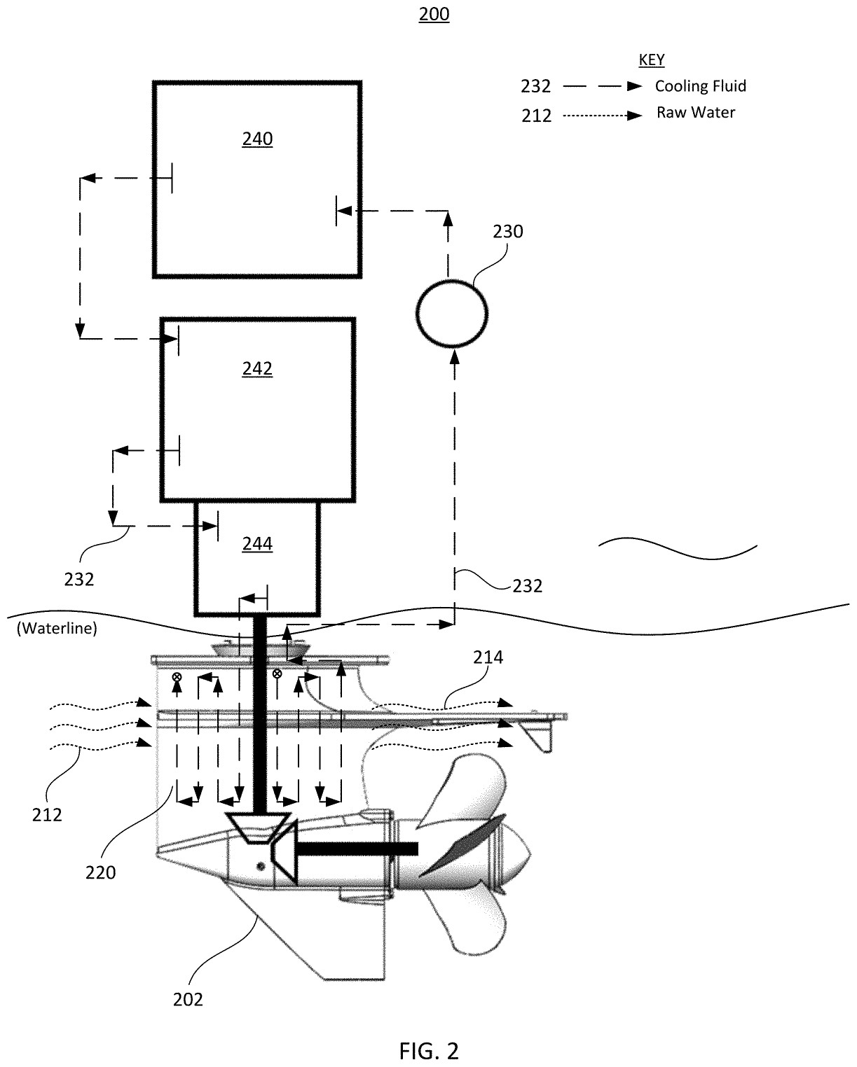

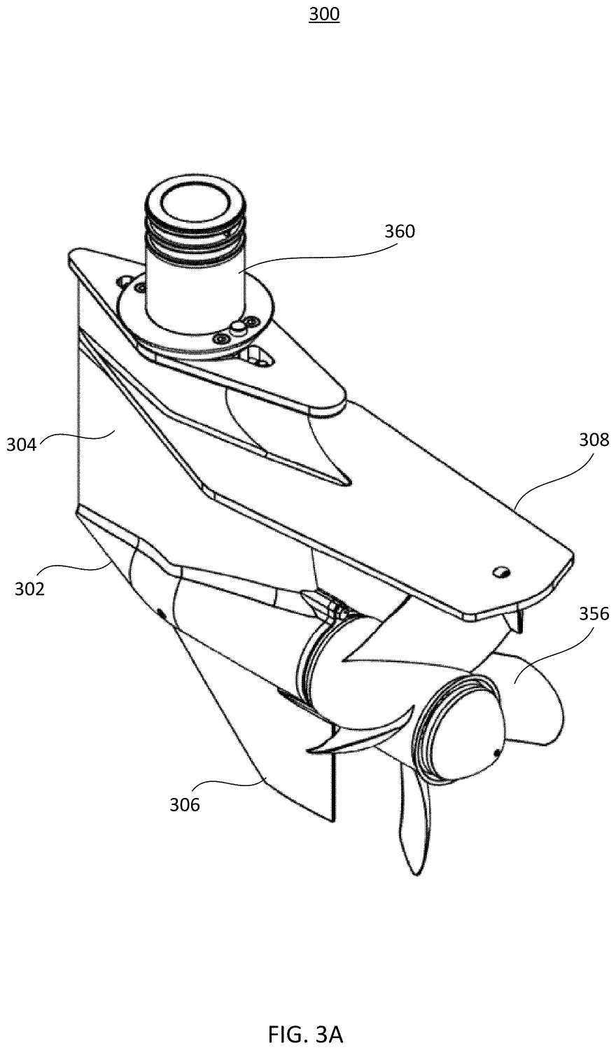

In contrast to the traditional cooling systems utilized by outboard and stern drive boat engines, FIG. 2 illustrates a diagram 200 of an improved closed loop heat exchanger system where the heat exchange portion or unit is disposed in a lower housing or drive unit of a boat motor assembly. Here a series of cooling channels 220 traverse back and forth internally or inside the housing of the lower drive unit 202. The external surface of the lower drive unit 202 is thermally conductive and as such can transfer heat away from the lower drive unit into the body of water where it resides. As noted by the waterline in FIG. 2, the lower drive unit is designed to sit below the water line while in use. While the lower drive unit is in motion, raw 112 can pass by, over and around the lower drive unit 202, extract heat and disperse it as raw water 114. The cooling fluid 132 can be circulated down into the cooling channels 220, which form part of the heat exchanger unit, using a closed-circuit pump 230. This cooling is circulated through the various motor components that generate heat. In the instance of an electric motor, these components could include an inverter 240, a motor 242 and a gear reducer 244 as examples. Not shown, but components that also produce heat are batteries that power an electric motor, which could also be cooled utilizing this cooling system.

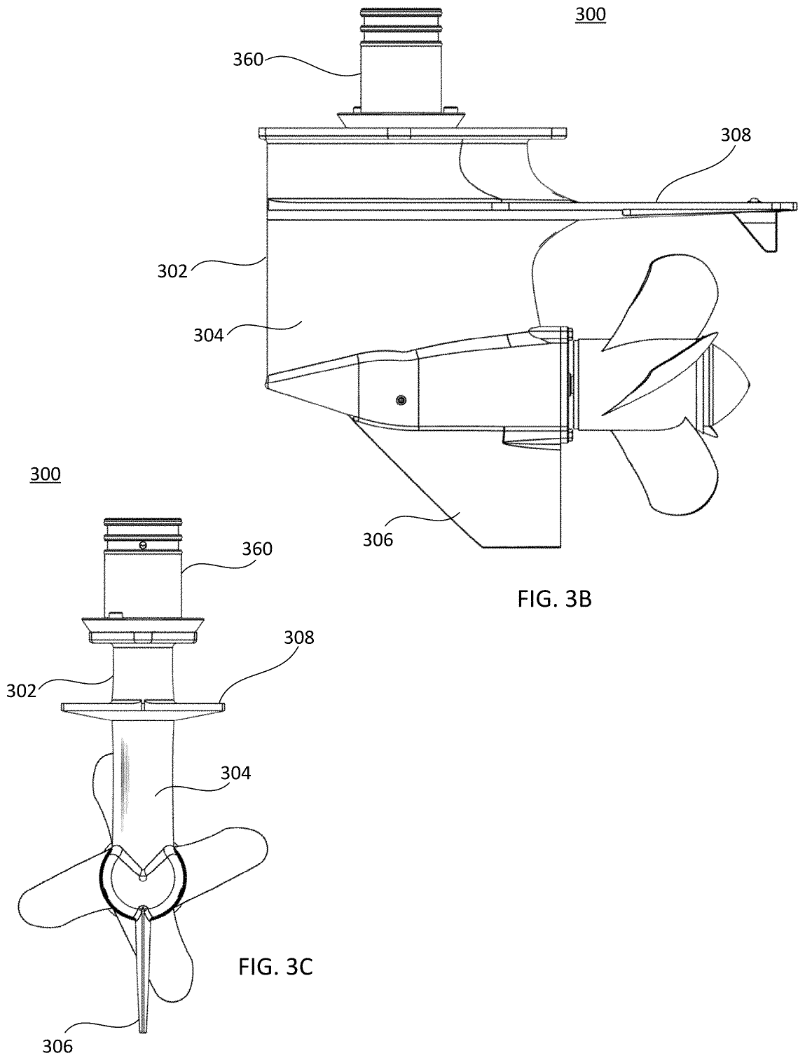

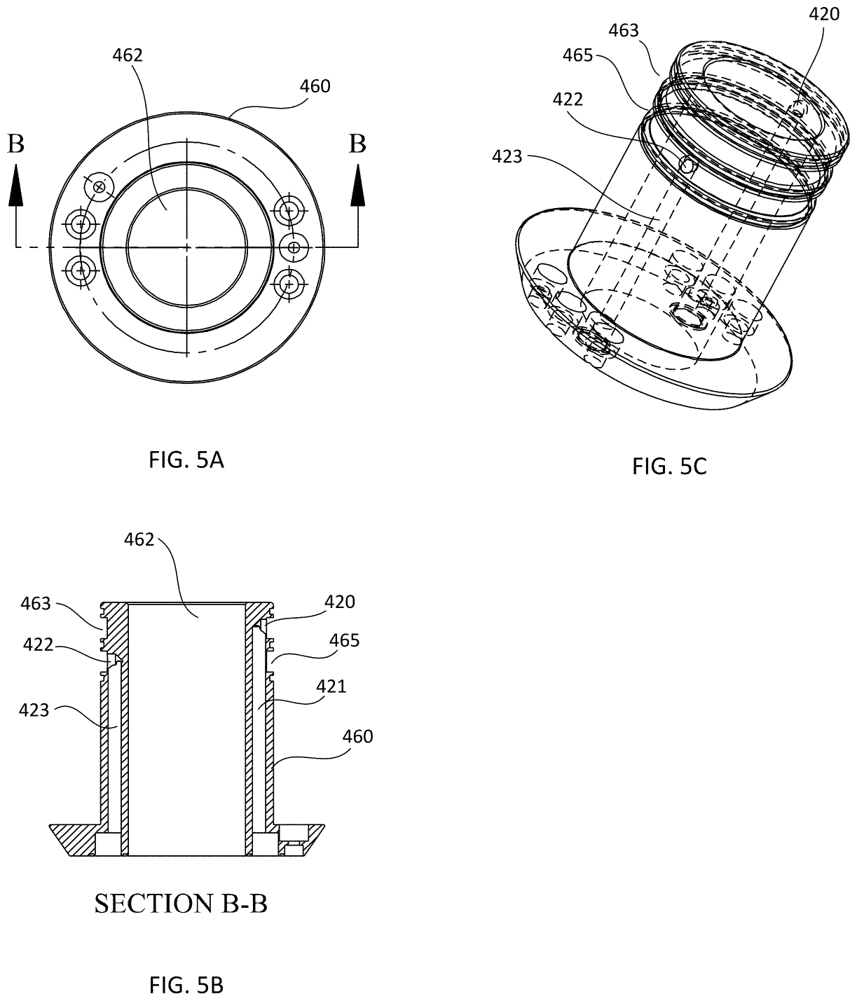

FIGS. 3A-C illustrates various views of an embodiment of a lower drive unit of a boat motor assembly that contains the propulsion system, where this closed-loop heat exchanger system could be integrated therein. FIG. 3A is a perspective view of a lower drive unit 300 that includes a lower drive unit housing 302, having an external surface 304 that is thermally conductive, a skeg fin 306 to provide stability, a propellor 356 as part of the propulsion system, an anti-cavitation plate 308 useful to direct and hold water around the propeller blades, thus reducing cavitation, and a Hub assembly 360, which will be discussed in more detail in FIGS. 5A-C. FIG. 3B illustrates a front of the lower drive unit 300 while FIG. 3C illustrates a side view of 300.

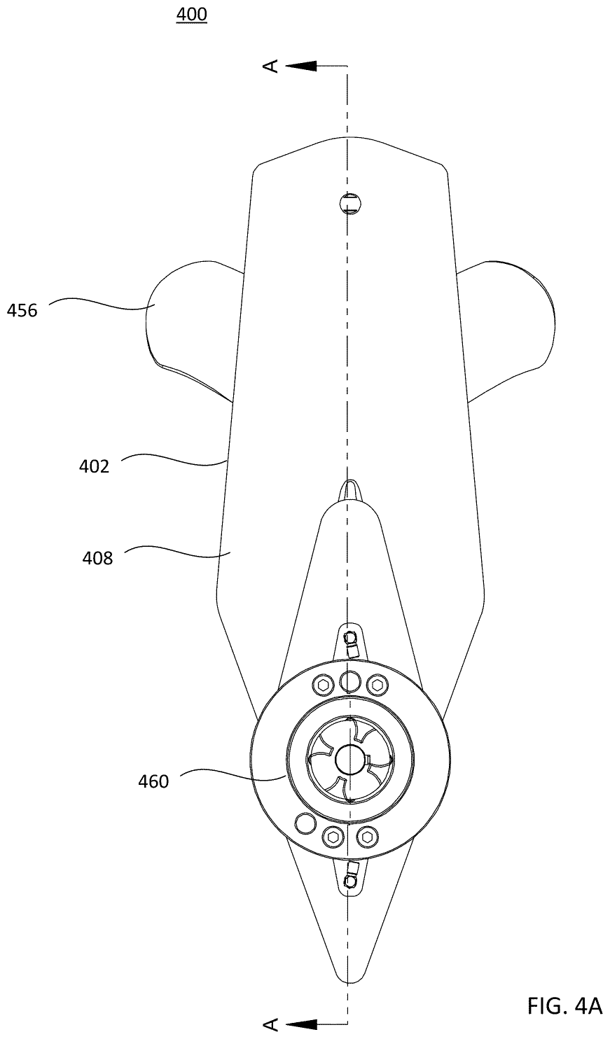

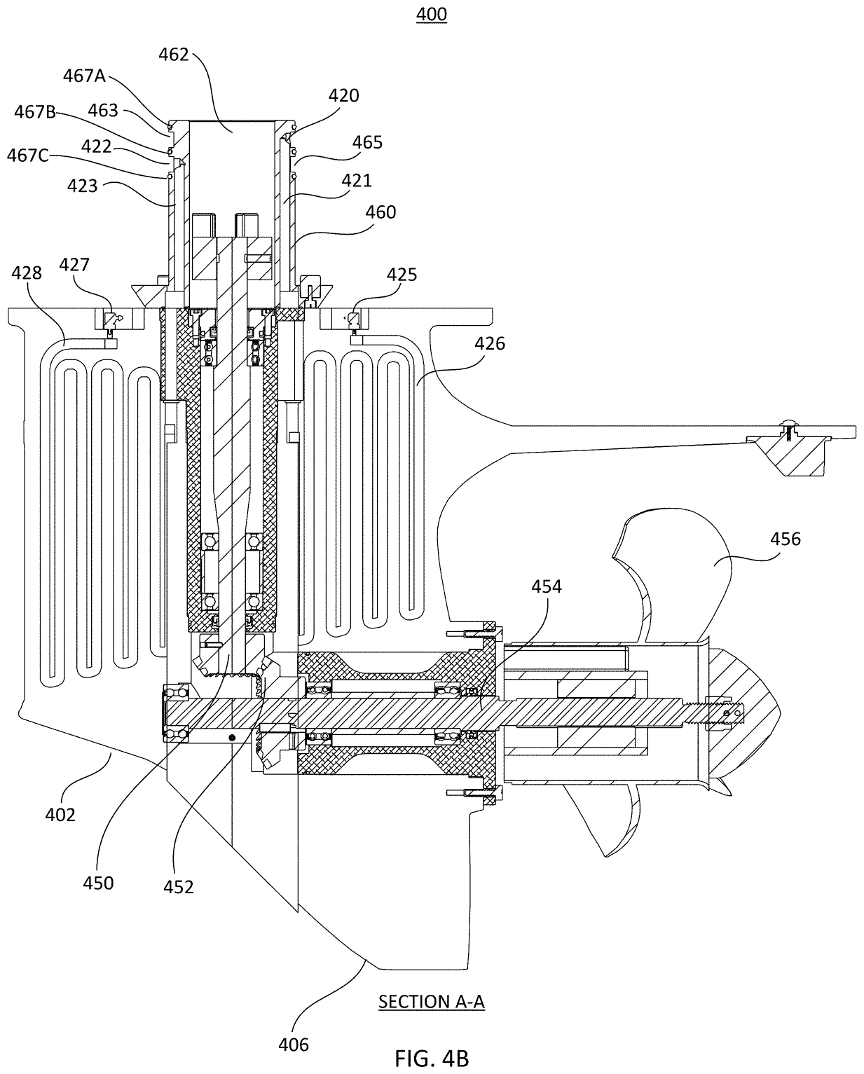

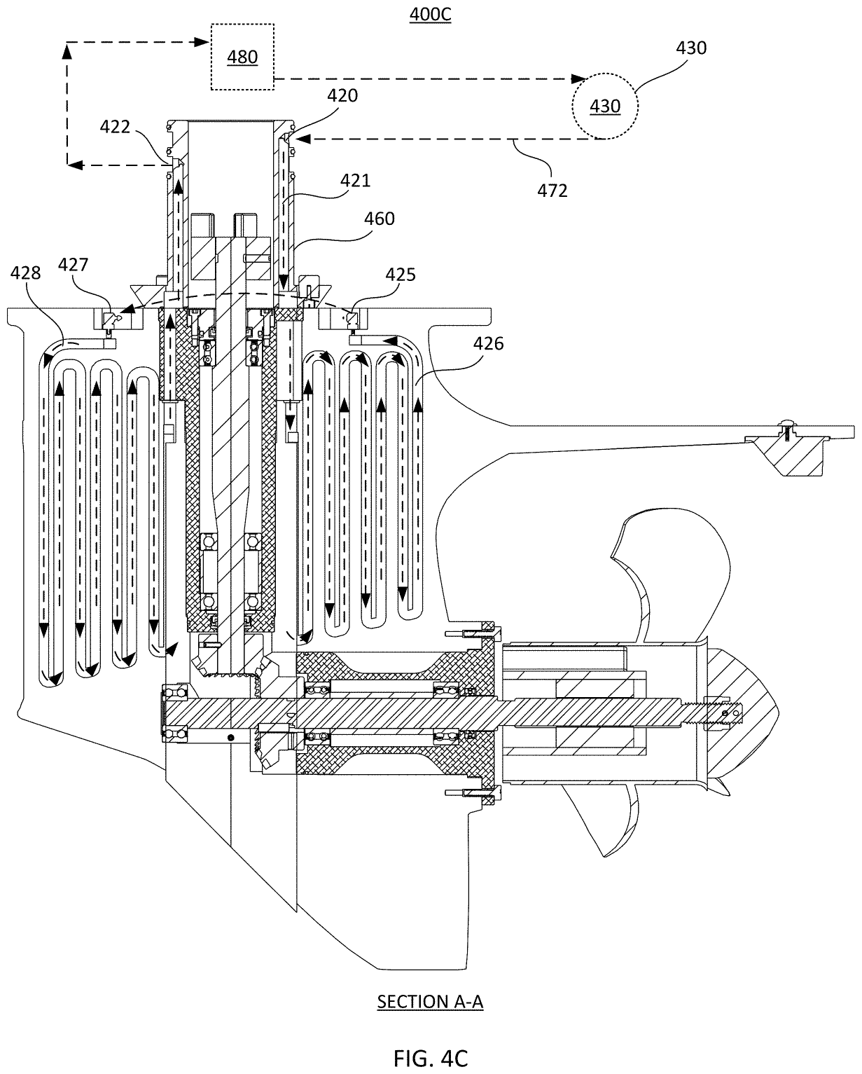

FIG. 4A illustrate a top view of a lower drive unit 400 of a boat motor assembly, such as that of an electric outboard motor system, that contains the propulsion system. From the top view, the Hub assembly 460 can be seen, as well as the anti-cavitation plate 408, the housing 402, and portions of the propeller 456.

Referring now to FIG. 4B, which is a cross-sectional view of 4A illustrating the internal components of the lower drive unit 400 including the improved heat exchanger system as noted and diagrammed in FIG. 2. The lower drive unit 400 includes a housing 402, skeg fin 406, lower drive shaft 450, which is configured to mechanically drive or rotate propeller shaft 454, by a gearing mechanism 452. The lower drive shaft 450 is driven by the motor system, not shown here, that is disposed in the upper housing unit or other portion examples of which are shown in the Appendix. Connected to an upper portion of the lower drive unit 400 is a hub assembly 460, which includes and forms part of an inlet channel 421 having an inlet 420 that opens from an upper radial channel 463. The inlet channel 421 is fluidly connected to a first portion of traversing channels 426 positioned on the aft or rearward portion of 400 and that form part of the heat exchanger system. Traversing channels 426 can be directly integrated or formed into the housing 402 of the lower drive unit 400. This direct integration allows for an improved thermal conductivity with the external surface of housing 402 that is in direct contact with the body of water. The traversing channels 426 use a port connector 425, which directs cooling fluid around the central portion of the lower drive unit where the lower drive shaft and components associated therewith are positioned via a channel or tube (not shown) to port connector 427, which feeds until a second set of traversing channels 428 positioned on the forward or bow facing portion of 400. 428 leads into the outlet channel 423, a part of which is formed by the hub assembly 460, which includes an outlet or aperture 422 that feeds into a lower radial channel 465 disposed about an exterior of 460. A plurality of sealing components 467A, 467B, and 467C can be disposed between the upper and lower radial channels 463 and 465 to seal the channels. The component they could seal with could be part of a slewing bearing system, an example which is described in the Appendix. These upper and lower radial channels can then be fluidly connected to the remaining portion of the closed-loop cooling circuit, which is diagrammed in FIG. 4C.

FIG. 4C uses the same cross-sectional view of 4A, but further illustrates the flow path of the cooling circuit and additional components in that circuit including a circulating pump 430, which could be mounted in an upper housing portion of the boat motor assembly. Thus, 400C is a diagrammed lower drive unit with a complete closed-loop cooling circuit pathway.

The fluid circuit passes through, by or about motor components represented by 480 where the cooling fluid 472 extracts heat generated by those components 480 and carries the heat down into the lower drive unit 400 and in the heat exchanger system formed in part by traversing channels 426 and 428. Directional flow arrows have been provided to illustrate how this fluidic circuit might look including going around the central portion of the lower drive unit from port 425 to port 427.

It should be noted that although no traversing channels are shown in the skeg fin portion, it could be conceived and designed to form traversing channels in that portion of the lower drive unit. Furthermore, and as part of the principles these embodiments are seeking to convey is that any portion of the lower drive unit that has available space could be utilized to form part of the heat exchanger system and cooling circuit, thus the shown examples should not deem to be limited to their current positions. Again, and by way of example, even the anti-cavitation plate could include heat exchanging fluidic channels.

At this point, the applicants would like to further point out additional advantages available to this type of system. As noted, the system is designed to be thermally conductive with the outer surface of the housing of the lower drive unit. By eliminating a raw water intake port, extra components include an extra pump are eliminated, clogging of an external pumping system is eliminated and increased performance is achieved. Some ways in which the increased performance is achieved is by eliminating raw water intake ports, which can increase drag, as well as eliminate other forms of drag that are created by alternative cooling systems such as keel coolers, which also reduce performance and are often designed for large vessels, such as cargo ships. Any time an external component is added to a boat and in particular to any part that is in the water or near the propulsion system can change the performance of the boat.

When utilizing an electric motor, it is important to reduce unwanted drag, so as to maximize the longevity of the batteries powering the electric motor. This is at least one reason why these closed-loop heat exchanger embodiments are well suited for use with electric motor driven boats. Other advantages include utilizing space in the lower drive unit that is not being realized, which frees up additional space in the upper housing unit. This is a sampling of the advantages and those skilled in the art may recognize even more advantages.

Referring now to FIGS. 5A-C, which illustrate the hub assembly 460 that includes the integrated inlet channel 421 and outlet channel 423 with corresponding inlet or aperture 420 and outlet or aperture 422. Also shown and labeled are the upper and lower radial channels 463 and 465 disposed radially about the hub assembly 460. FIG. 5A is a top view of hub assembly 460 with cross-section lines B-B, for which cross-section is shown in FIG. 5B that illustrates the internal cavity or opening 462 about which a portion of the lower drive shaft and portions of any coupling mechanisms connecting that to an upper drive shaft or motor can be disposed therein. FIG. 5C is illustrated as a transparent perspective to better show some of the elements previously described such as inlet and outlet channels 421 and 423.

It should be appreciated that hub assembly 460 enables for an efficient and complete cooling circuit as well as other mechanical components to pass therethrough. Additionally, when coupled to a slewing bearing system, such as that shown in the Appendix, enables the lower drive unit to pivot or rotate 360 degrees and more. This allows for improved maneuverability in the water.

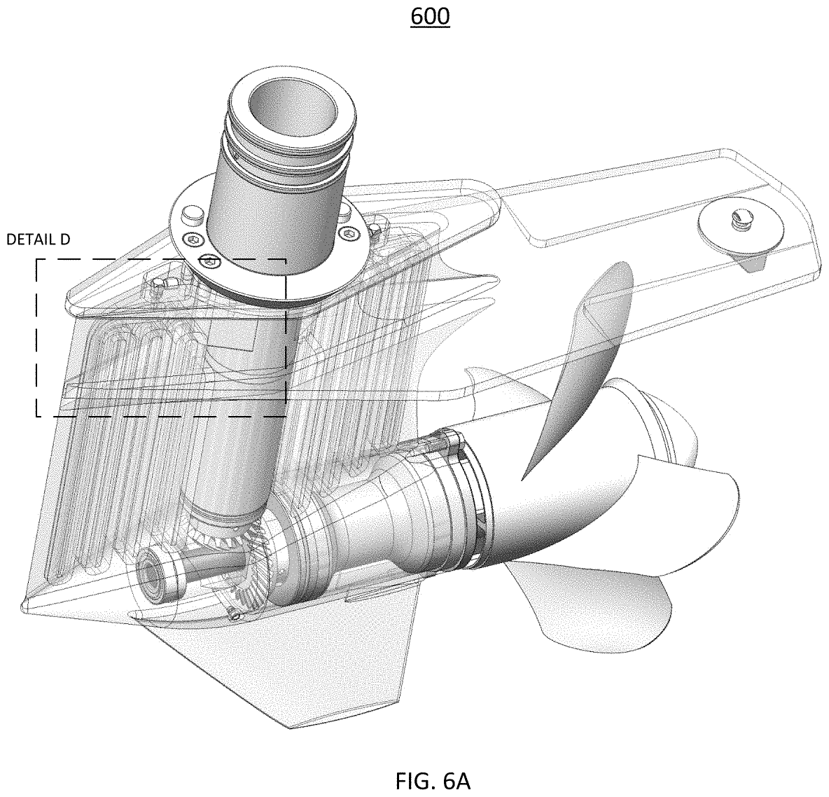

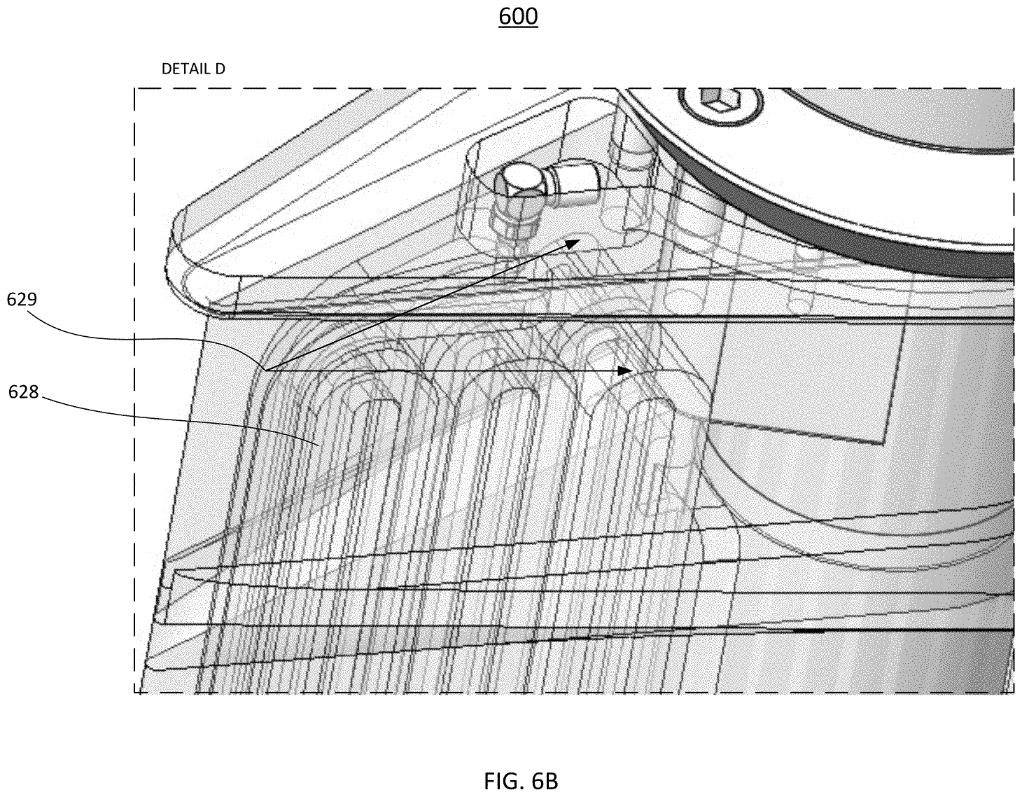

FIGS. 6A-B illustrate an alternative embodiment of positioning or forming the traversing channels that form a part of the heat exchanger system in the lower drive unit. FIG. 6A illustrates transparent perspective view of a lower drive unit 600 having an alternative configuration for integrating traversing channels therein that form part of the heat exchanger system.

FIG. 6B illustrates an enlarged view of the Detail D section of FIG. 6A. Here it can be seen that the traversing channels 628 form a V pattern 629, so to as be closer to the external surface of the housing of the lower drive unit. Thus, one of the principles being conveyed here is that the traversing cooling channels 628 can be formed to be correspond to the shape of the lower drive unit 600. By placing the traversing channels closer to the external surface, it reduces the thermal resistance caused by the geometry and wall thickness of the housing.

It should be noted that the heat exchanger or heat exchanger assembly can be formed in at least in part by the traversing channels, portions of the exterior surface of the housing of the lower drive unit, and portions of the housing where the traversing channels are formed or connecting thereto. In short, any portion which aids in the transfer of heat away from the cooling fluid and into the body of water can be considered as part of the heat exchanger system. Having said the critical component are the traversing channels. Though the term traversing is used to describe the back-and-forth nature of some portions of the channels, that term is not meant to be limiting. In other words, the channels could be designed to not actually traverse, but follow curvature of the lower drive unit or otherwise optimized to increase surface area for extracting heat away from the cooling fluid.

A common cooling fluid is propylene glycol also known as glycol, but any fluid that can help extract heat and carry it away from the heat source could be utilized.

The lower drive unit can be formed of aluminum or other metal that is thermally conductive. A thermally conductive coating or paint can be disposed on the external surface of the housing of the lower drive unit.

While, the principles of the invention have been described herein, it is to be understood by those skilled in the art that this description is made only by way of example and not as a limitation as to the scope of the invention. Other embodiments are contemplated within the scope of the present invention in addition to the exemplary embodiment shown and describe herein. Modifications and substitutions by one of ordinary skill in the art are considered to be within the scope of the present invention.

1. A closed loop heat exchanger system for use with an outboard motor comprising:
a lower drive unit configured to support a propulsion system, wherein a majority of the lower drive unit is disposed in the water when in operation;
a heat exchanger assembly disposed internally within the lower drive unit, and configured to be in thermal communication with an external surface of the lower drive unit; and
a fluidic pump in fluid communication with the heat exchanger assembly;
an inlet channel directing a cooling fluid from the fluidic pump into the lower drive unit and into the heat exchanger assembly; and
an outlet channel directing the cooling fluid having passed through the heat exchanger assembly into, over or about heat generating motor components disposed outside the lower drive unit.

2. The closed loop heat exchanger system for use with an outboard motor of claim 1, wherein the heat generating motor components include at least one of: an electric motor, an inverter and gear reducer.

3. The closed loop heat exchanger system for use with an outboard motor of claim 1, further including a hub assembly disposed on an upper portion of the lower drive unit and wherein the hub assembly forms a part of the inlet channel and the outlet channel.

4. The closed loop heat exchanger system for use with an outboard motor of claim 3, wherein the hub assembly includes a cavity portion that is configured to receive a portion of a lower drive shaft therein.

5. The closed loop heat exchanger system for use with an outboard motor of claim 1, wherein the heat exchanger assembly is comprised of at least one channel traversing about itself along at least one plane.

6. The closed loop heat exchanger system for use with an outboard motor of claim 5, wherein the traversing channel is formed into a sidewall of a housing of the lower drive unit.

7. The closed loop heat exchanger system for use with an outboard motor of claim 1, wherein the heat exchanger assembly is comprised of a first set of traversing channels disposed about a rear portion of the lower drive unit and a second set of traversing channels disposed about the front portion of the lower drive unit.

8. The closed loop heat exchanger system for use with an outboard motor of claim 7, wherein the traversing channels are at least partially formed into one or more sidewalls of a housing of the lower drive unit, and wherein the one or more sidewalls form a portion of an exterior surface of the housing.

9. The closed loop heat exchanger system for use with an outboard motor of claim 3, wherein the hub assembly enables the lower drive unit to be rotated 360 degrees when connected to a slewing assembly.

10. A closed loop heat exchanger system for use with a stern drive comprising:
a lower drive unit configured to support a propulsion system, wherein a majority of the lower drive unit is disposed in the water when in operation;
a heat exchanger assembly disposed internally within the lower drive unit, and configured to be in thermal communication with an external surface of the lower drive unit; and
a fluidic pump in fluid communication with the heat exchanger assembly;
an inlet channel directing a cooling fluid from the fluidic pump into the lower drive unit and into the heat exchanger assembly; and
an outlet channel directing the cooling fluid having passed through the heat exchanger assembly into, over or about heat generating motor components disposed outside the lower drive unit.

11. The closed loop heat exchanger system for use with a stern drive of claim 10, wherein the heat generating motor components include at least one of: an electric motor, an inverter and gear reducer.

12. The closed loop heat exchanger system for use with a stern drive of claim 10, further including a hub assembly disposed on an upper portion of the lower drive unit and wherein the hub assembly forms a part of the inlet channel and the outlet channel.

13. The closed loop heat exchanger system for use with a stern drive of claim 12, wherein the hub assembly includes a cavity portion that is configured to receive a portion of a lower drive shaft therein.

14. The closed loop heat exchanger system for use with a stern drive of claim 10, wherein the heat exchanger assembly is comprised of at least one channel traversing about itself along at least one plane.

15. The closed loop heat exchanger system for use with a stern drive of claim 14, wherein the traversing channel is formed into a sidewall of a housing of the lower drive unit.

16. The closed loop heat exchanger system for use with a stern drive of claim 10, wherein the heat exchanger assembly is comprised of a first set of traversing channels disposed about a rear portion of the lower drive unit and a second set of traversing channels disposed about the front portion of the lower drive unit.

17. The closed loop heat exchanger system for use with a stern drive of claim 16, wherein the traversing channels are at least partially formed into one or more sidewalls of a housing of the lower drive unit, and wherein the one or more sidewalls form a portion of an exterior surface of the housing.

18. The closed loop heat exchanger system for use with a stern drive of claim 12, wherein the hub assembly enables the lower drive unit to be rotated 360 degrees when connected to a slewing assembly.
